(19) United States
(12) Patent Application Publication
(10) Pub. No.: US 2014/0035469 A1
(43) Pub. Date: Feb. 6, 2014

(54) LIGHT EMITTING DEVICE

(71) Applicant: GIO Optoelectronics Corp., Tainan City (TW)

(72) Inventor: WU-CHANG YANG, Tainan City (TW)

(73) Assignee: GIO Optoelectronics Corp., Tainan City (TW)

(21) Appl. No.: 13/951,456

(22) Filed: Jul. 25, 2013

(30) Foreign Application Priority Data
Aug. 1, 2012 (TW) 101127763

(51) Int. Cl. H05B 33/08

(52) U.S. Cl. CPC H05B 33/0809
USPC 315/161

(57) ABSTRACT

A light emitting device is electrically connected to a three-phase AC power source and comprises three light emitting modules. The light emitting modules respectively receives three phase power sources of the three-phase AC power source. Each of the light emitting modules includes a light emitting unit and a control circuit electrically connected to the light emitting unit. Each of the control circuits controls the light output power of the corresponding light emitting unit according to the voltage variation or phase variation of the received phase power source, and the three light emitting modules are collectively kept a stable gross light output power.

### CROSS REFERENCE TO RELATED APPLICATIONS

This Non-provisional application claims priority under 35 U.S.C. §119(a) on Patent Application No(s). 101127763 filed in Taiwan, Republic of China on Aug. 1, 2012, the entire contents of which are hereby incorporated by reference.

### BACKGROUND OF THE INVENTION

1. Field of Invention

The invention relates to a light emitting device and, in particular, to a light emitting device including light emitting diodes (LED) driven by a multi-phase power source.

2. Related Art

With the raised environmental consciousness, traditional lamps have been unable to meet the energy saving requirement due to its high energy consumption and short lifespan. Now, light emitting diodes (LED) have been commercialized with the progress of the semiconductor technology, and they are widely applied to various appliances in our daily life due to their advantages like long lifespan, small size, less power consumption, colorfulness and rapid response speed.

The LED lamp has many advantages, but however, it still has some problems to be solved. For example, when the LED lamp is driven by an alternating current (AC) power source, an AC to DC power converter is usually required to generate a constant current for driving the LED lamp. In general, this kind of power converter can achieve voltage stabilization by an electrolytic capacitor. However, the electrolytic capacitor can not work in high temperature and has a relatively short lifespan. So, the LED lamp's lifespan will be limited thereby. Besides, if the electrolytic capacitor is not used in the driver circuits, the driving voltage will fluctuate more largely to cause the LED lamp to flicker, but the LED lamp's lifespan will not be limited.

Therefore, it is an important subject to provide a light emitting device that can be driven by an AC power source, achieve voltage stabilization without electrolytic capacitors, and possess advantages of stable light output power and steady light output (without flickers) for achieving the effects of energy saving, no flickers and long lifespan.

### SUMMARY OF THE INVENTION

In view of the foregoing subject, an objective of this invention is to provide a light emitting device that can be driven by an AC power source, achieve voltage stabilization without electrolytic capacitors, and possess advantages of stable light output power and steady light output (without flickers) for achieving the effects of energy saving, no flickers and long lifespan.

To achieve the above objective, a light emitting device according to the invention is electrically connected to a three-phase AC power source and comprises three light emitting modules. The light emitting modules respectively receives three phase power sources of the three-phase AC power source. Each of the light emitting modules includes a light emitting unit and a control circuit electrically connected to the light emitting unit. Each of the control circuits controls the light output power of the corresponding light emitting unit according to the voltage variation or phase variation of the received phase power source, and the three light emitting modules are collectively kept a stable gross light output power.

In one embodiment, the light emitting unit of each of the light emitting modules includes at least a light emitting diode (LED).

In one embodiment, the control circuit of each of the light emitting modules includes a resistor.

In one embodiment, the control circuit of each of the light emitting modules includes a first rectifier, a second rectifier, a first current source and a second current source. The first rectifier is electrically connected to the three-phase AC power source. The second rectifier is electrically connected to the corresponding light emitting unit. The first current source is electrically connected to the first rectifier to form a first current path. The second current source is electrically connected to the second rectifier to form a second current path. The first and second current paths are connected in parallel.

In one embodiment, the control circuit of each of the light emitting modules includes a rectifier, a current source and a controller. The rectifier is electrically connected to the three-phase AC power source and receives the phase power source to output a DC voltage. The current source is electrically connected to the rectifier and the corresponding light emitting unit. The controller is electrically connected to the rectifier and the current source, and controls the light output power of the corresponding light emitting unit according to the level variation or phase variation of the DC voltage.

In one embodiment, the control circuit of each of the light emitting modules includes a rectifier, a current source, a first controller, a second controller and a switch unit. The rectifier is electrically connected to the three-phase AC power source and receives the phase power source to output a DC voltage. The current source is electrically connected to the rectifier and the corresponding light emitting unit. The first controller is electrically connected to the rectifier and the current source, and controls the outputted current of the current source according to the level variation or phase variation of the DC voltage. The second controller is electrically connected to the rectifier. The switch unit is electrically connected to the second rectifier and the light emitting unit. The second controller controls the switch unit according to the level variation or phase variation of the DC voltage for adjusting the current supplied to the light emitting unit.

In one embodiment, the light output power waveform of the light emitting unit of each of the light emitting modules has a power ascending section and a power descending section, and the power ascending section of the waveform of one of the light emitting units overlaps the power descending section of the waveform of another of the light emitting units.

In one embodiment, the power ascending section and the power descending section overlapping each other have complementary slopes.

In one embodiment, the light output power waveform of the light emitting unit of each of the light emitting modules has a power stabilized section, which is between the power ascending section and the power descending section.

In one embodiment, the three light emitting modules emit light in a staggered manner.

In one embodiment, the ripple RMS of the gross light output power of the light emitting modules is less than 10% of the RMS of the gross light emitting power.

In one embodiment, the light output power waveforms of the light emitting units have phases different from one another by 120°.

In one embodiment, the light output power waveforms of the light emitting units are substantially the same and have phases different from one another by 120°.

In one embodiment, the control circuit of each of the light emitting modules includes a rectifier, a plurality of detectors, a plurality of switch units and a plurality of controllers. The rectifier is electrically connected to the three-phase AC power source and receives the phase power source to output a DC voltage to the light emitting unit. The detectors detect the light emitting states of the LEDs of the light emitting unit to output control signals, receptively. The switch units are connected in series and electrically connected to the corresponding LEDs respectively. The controllers are electrically connected to the switch units respectively, and adjust the number of the turned on LEDs of the light emitting unit according to the control signals of the detectors respectively.

As mentioned above, in the light emitting device according to the invention, the electrolytic capacitor is not required for the voltage stabilization, and the light output power of each of the light emitting modules is controlled according to the voltage variation or phase variation of the power source. Thereby, a stable light output power can be provided. Besides, the invention can bring the advantages of a longer lifespan and no flickers, and huge market potential.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic circuit diagram of a light emitting device according to an embodiment of the invention;

FIG. 2A is a schematic circuit diagram of a light emitting module of the light emitting device according to an embodiment of the invention;

FIG. 2B is a schematic diagram of the light output power waveforms of the light emitting modules in FIG. 2A driven by a three-phase AC power source;

FIGS. 3, 4A, 4B, 5A, 5B, 5C, 5D and 6 are schematic diagrams of variations of the light emitting module according to an embodiment of the invention; and

FIGS. 7A to 7C are schematic diagrams of variations of the light output power waveforms of the light emitting modules driven by a three-phase AC power source.

### DETAILED DESCRIPTION OF THE INVENTION

The present invention will be apparent from the following detailed description, which proceeds with reference to the accompanying drawings, wherein the same references relate to the same elements.

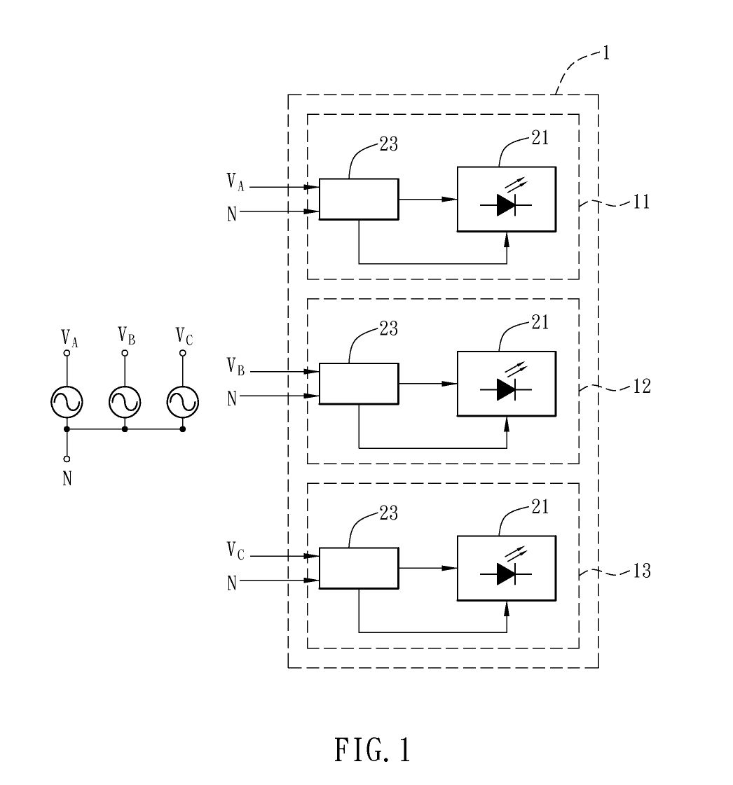

FIG. 1 is a schematic circuit diagram of a light emitting device 1 according to an embodiment of the invention. As shown in FIG. 1, the light emitting device 1 is electrically connected to a three-phase AC power source, and includes three light emitting modules 11, 12, 13.

The light emitting module 11 is connected to a phase power source V_{A} and neutral line N of the three-phase AC power source, the light emitting module 12 is connected to a phase power source V_{B} and the neutral line N of the three-phase AC power source, and the light emitting module 13 is connected to a phase power source V_{C} and the neutral line N of the three-phase AC power. Each of the light emitting modules 11, 12, 13 has a light emitting unit 21 and a control circuit 23, and the light emitting unit 21 is electrically connected to the control circuit 23. In this embodiment, light emitting diodes (LEDs) are used as the light source of the light emitting unit 21, and the number and circuit layout of the LEDs can be changed according to the practical requirements. Each of the control circuits 23 controls the light output power of the corresponding light emitting unit 21 according to the voltage variation or phase variation of the received phase power source V_{A}, V_{B} or V_{C}.

The following is a further illustration of the circuits of the light emitting modules 11, 12 and 13 of the light emitting device 1, and the light emitting module 11 will be taken as an example herein for the illustration. Besides, since the circuits of the light emitting modules 11, 12 and 13 are the same, the illustration of the light emitting modules 12 and 13 are omitted herein for the conciseness.

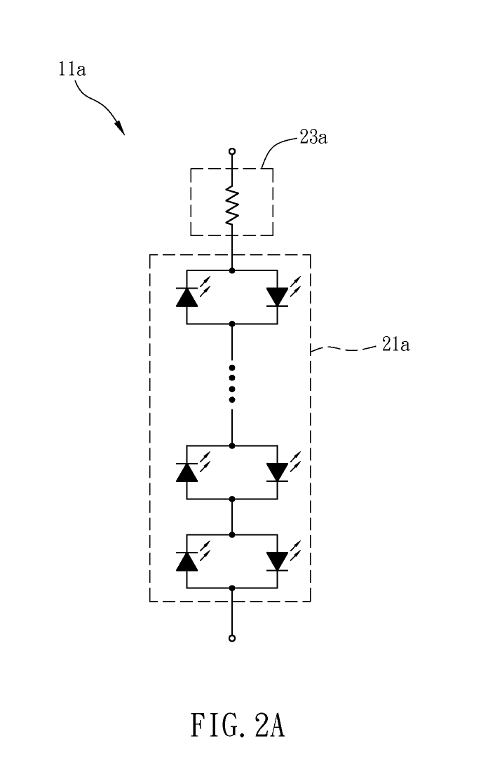

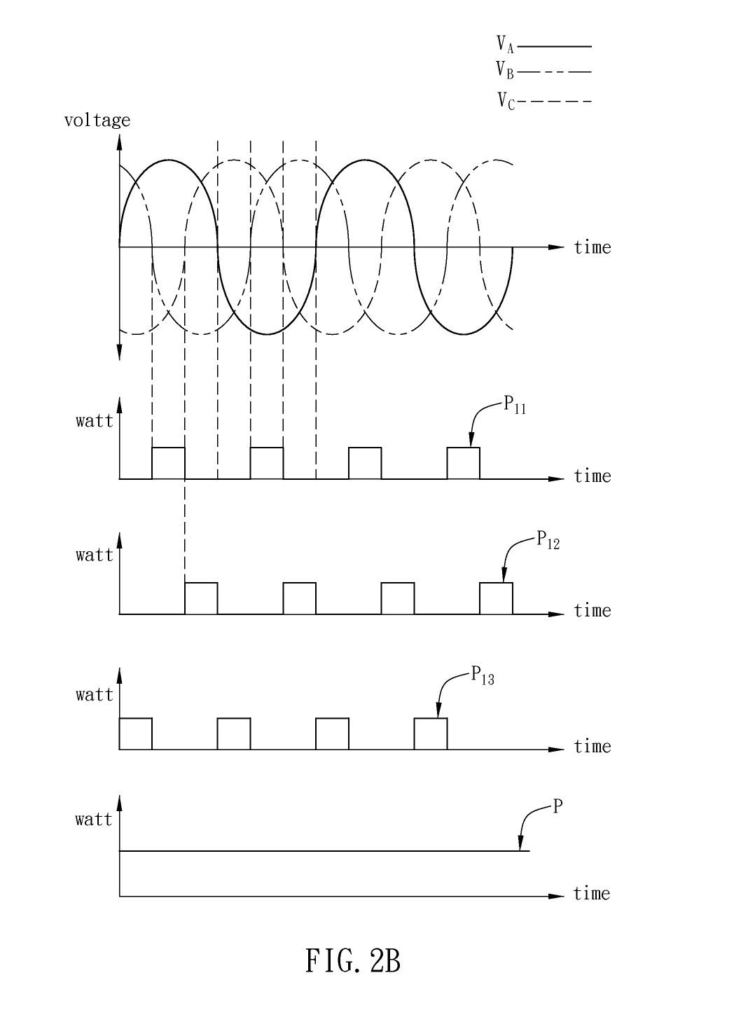

FIG. 2A is a schematic circuit diagram of a light emitting module 11a of the light emitting device according to an embodiment of the invention. As shown in FIG. 2A, the light emitting module 11a includes a light emitting unit 21a and a control circuit 23a. The light emitting unit 21a includes a plurality of groups of inverse-parallel connected LEDs, and the groups are connected in series. The control circuit 23a is composed of a single resistor. FIG. 2B is a schematic diagram showing the light output power waveform of the light emitting device including the circuit in FIG. 2A and driven by a three-phase AC power source. FIG. 2B sequentially shows, from top to bottom, the voltage waveforms of the phase power sources V_{A}, V_{B}, V_{C} of the three-phase AC power source, the light output power P₁₁ of the light emitting module receiving the phase power source V_{A}, the light output power P₁₂ of the light emitting module receiving the phase power source V_{B}, the light output power P₁₃ of the light emitting module receiving the phase power source V_{C}, and the gross light output power P of the light emitting device. As shown in FIG. 2B, the light emitting modules emit light sequentially according to the phase power sources V_{A}, V_{B}, V_{C}. Therefore, the phase difference of the light output power waveforms of the light emitting modules is 120° from one another, and thus the gross light output power P of the light emitting device can be kept stable.

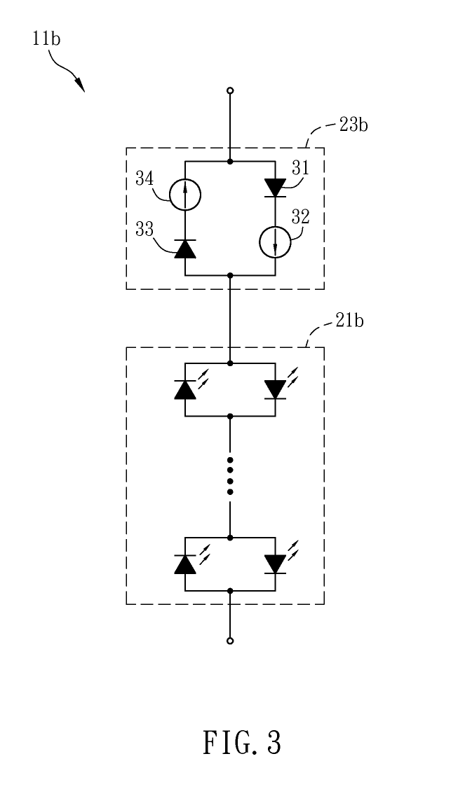

FIG. 3 is a schematic circuit diagram of a light emitting module 11b of the light emitting device according to another embodiment of the invention. As shown in FIG. 3, the light emitting module 11b includes a light emitting unit 21b and a control circuit 23b. The light emitting unit 21b includes a plurality of groups of inverse-parallel connected LEDs. The control circuit 23b includes a first rectifier 31, a second rectifier 33, a first current source 32 and a second current source 34.

The first rectifier 31 is electrically connected to the three-phase AC power source. The second rectifier 33 is electrically connected to the light emitting unit 21b. The first and second rectifiers 31 and 33 can be a diode each. The first current source 32 is electrically connected to the first rectifier 31 to form a first current path. The second current source 34 is electrically connected to the second rectifier 33 to form a second current path. The first current path and the second current path are connected in parallel. In detail, the first and second current paths provide bidirectional current to the light emitting unit 21b so that the gross light output power of the light emitting device can be kept stable.

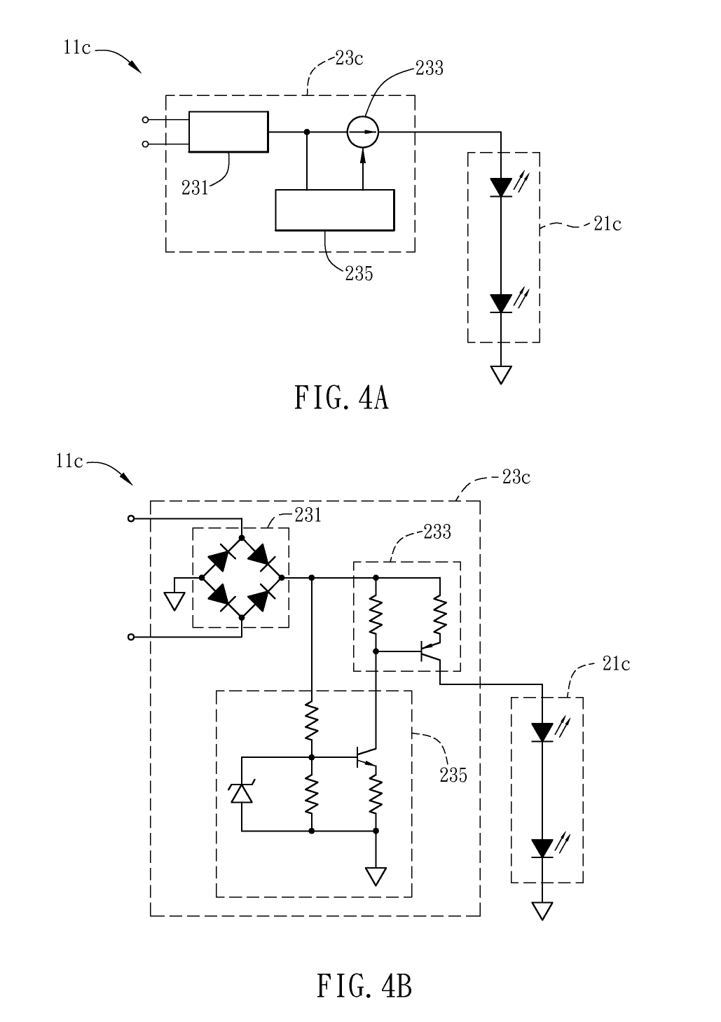

FIG. 4A is a schematic circuit diagram of a light emitting module 11c of the light emitting device according to another embodiment of the invention. As shown in FIG. 4A, the light emitting module 11c includes a light emitting unit 21c and a control circuit 23c. The light emitting unit 21c includes two LEDs connected in series. The control circuit 23c includes a rectifier 231, a current source 233 and a controller 235. To be noted, the light emitting unit 21c composed of two LEDs connected in series is just for example, and the number of the LEDs can be changed in other embodiments.

The rectifier 231 is electrically connected to the three-phase AC power source and receives the phase power sources thereof to output a DC voltage. The current source 233 is electrically connected to the rectifier 231 and the light emitting unit 21c. The controller 235 is electrically connected to the rectifier 231 and the current source 233, and adjusts the current outputted by the current source 233 according to the level variation or phase variation of the DC voltage for controlling the light output power of the light emitting unit 21c.

The light emitting module 11c is further illustrated by referring to FIG. 4B. As shown in FIG. 4B, the rectifier 231 can be a bridge rectifier. The current source 233 has a plurality of resistors and a transistor to provide a stable current. The controller 235 has a plurality of resistors, a transistor and a Zener diode so as to control the current value of the current source 233 according to the level variation of the rectified DC voltage. To be noted, the rectifier 231 can, without an electrolytic capacitor, offer a DC voltage with a large level variation to the current source 233 so that the current source 233 can output the required current to the light emitting unit 21c under the control of the controller 235.

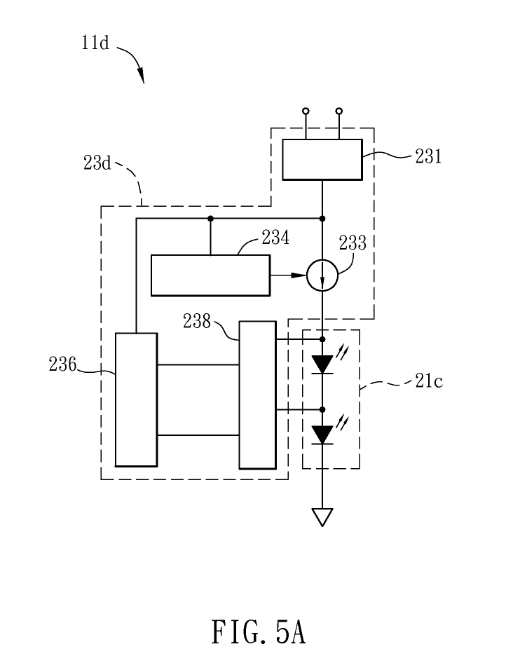

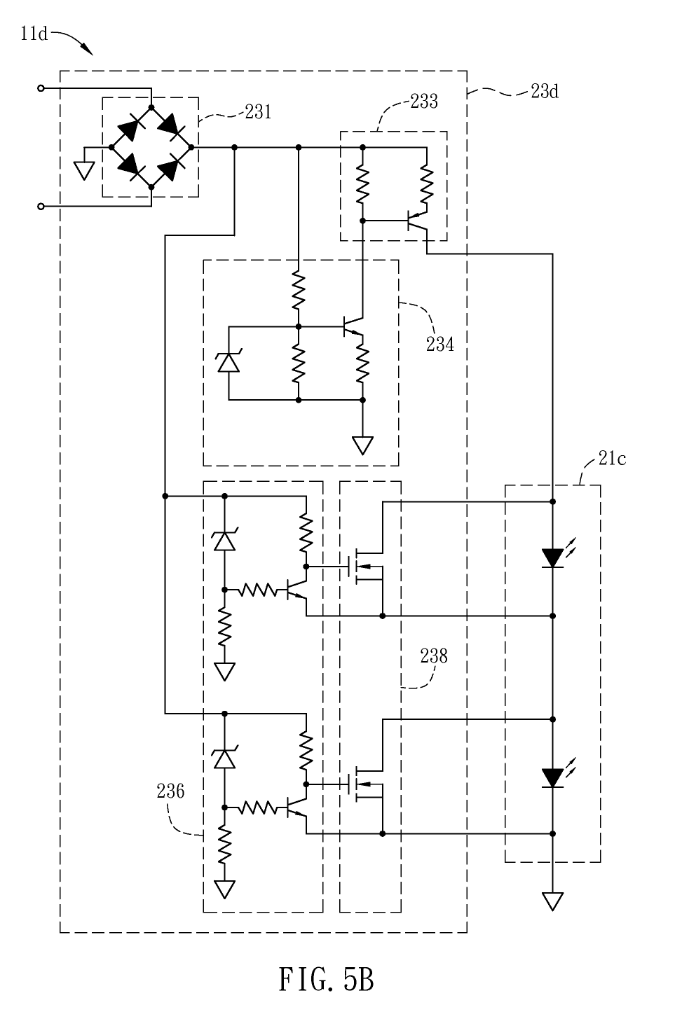

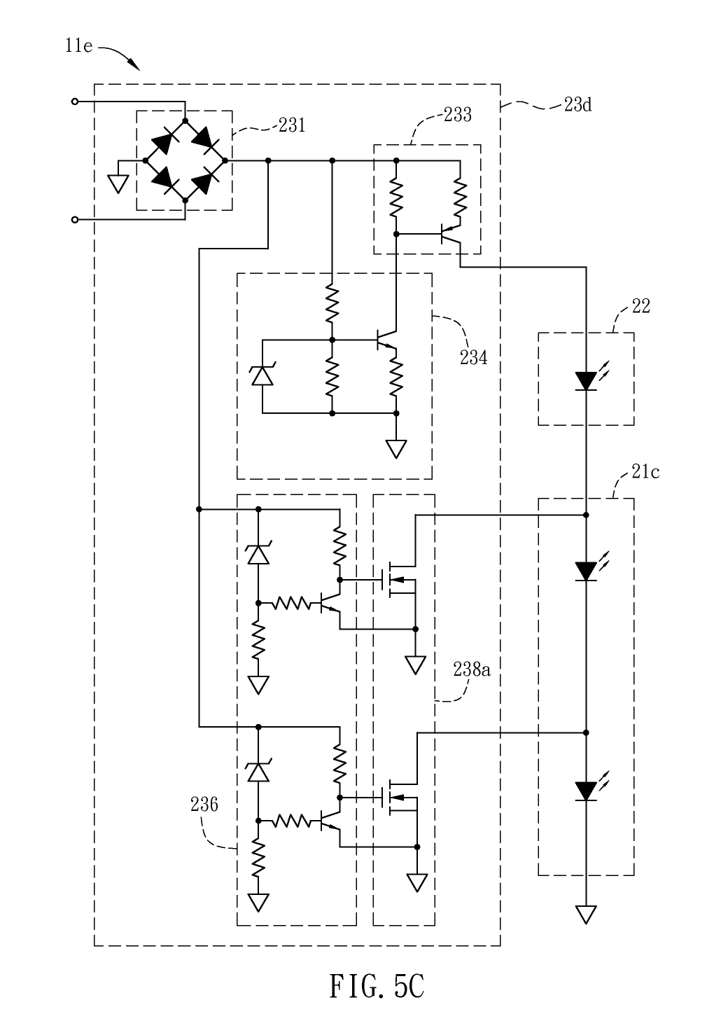

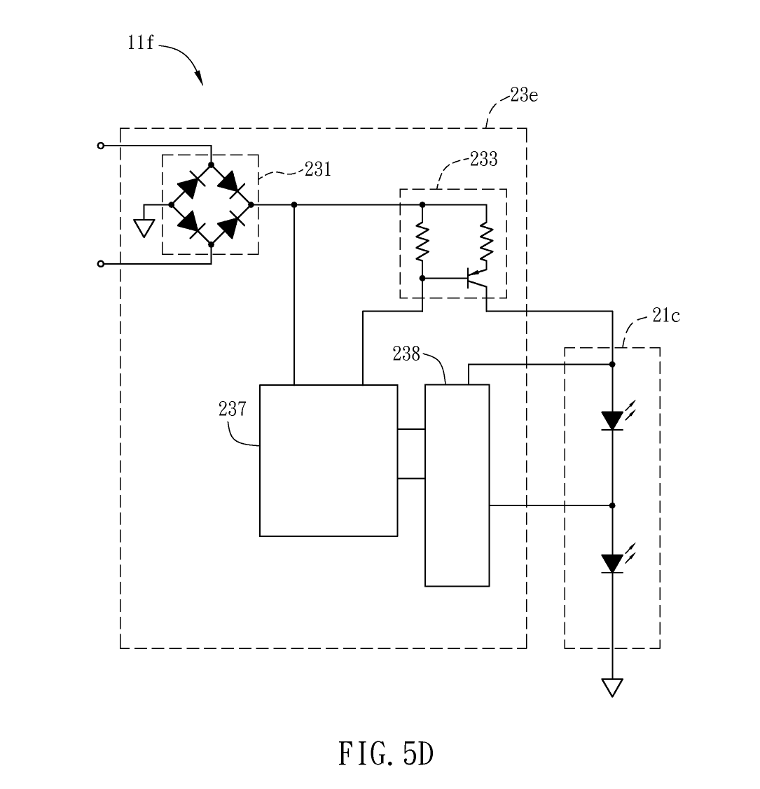

FIG. 5A is a schematic circuit diagram of a light emitting module 11d of the light emitting device according to another embodiment of the invention. As shown in FIG. 5A, the light emitting module 11d includes a light emitting unit 21c and a control circuit 23d. The control circuit 23d includes a rectifier 231, a current source 233, a first controller 234, a second controller 236 and a switch unit 238.

The rectifier 231 is electrically connected to the three-phase AC power source and receives the phase power sources thereof to output a DC voltage. The current source 233 is electrically connected to the rectifier 231 and the light emitting unit 21c. The first controller 234 is electrically connected to the rectifier 231 and the current source 233, and controls the outputted current of the current source 233 according to the level variation or phase variation of the DC voltage. The second controller 236 is electrically connected to the rectifier 231. The second controller 236 controls the switch unit 238 according to the level or phase variation of the DC voltage to adjust the current amount supplied to the light emitting unit 21c.

The light emitting module 11d is further illustrated by referring to FIG. 5B. Since the rectifier 231, current source 233 and first controller 234 of the control circuit 23d of the light emitting module 11d are the same as the rectifier 231, current source 233 and controller 235 of the light emitting module 11c, they are not described here for conciseness. The second controller 236 has a plurality of resistors, a plurality of transistors and a plurality of Zener diodes. The switch unit 238 has two transistor switches connected in series. The second controller 236 controls the “on” and “off” of the transistor switches of the switch unit 238 according to the level variation of the rectified DC voltage so as to partially or completely shunt the current supplied to the light emitting unit 21c. In other words, the current amount inputted to the light emitting unit 21c can be adjusted, so that the light output power of the light emitting unit 21c is controlled.

FIG. 5C is a schematic circuit diagram of a light emitting module 11e of the light emitting device according to another embodiment of the invention. Different from the light emitting module 11d, the switch unit 238a of the light emitting module 11e includes two transistor switches connected in parallel. The operation principle of the light emitting module 11e can be known by referring to the light emitting module 11d, and therefore it is not described here for conciseness.

Besides, the light emitting module 11e further includes an additional light emitting element 22 which is coupled between the light emitting unit 21c and the current source 233. Once the current source 233 starts to operate, the light emitting element 22 will emit light. In other words, no matter how the light emitting state of the light emitting unit 21c is, the light emitting element 22 will emit light as soon as the current source 233 starts to operate, and therefore the light emitting module 11e can retain a minimum light output power.

As shown in FIG. 5D, a light emitting module 11f includes a light emitting unit 21c and a control circuit 23e. Different from the light emitting module 11d, the first and second controllers are integrated to one control processing unit 237 for the light emitting module 11f. The control processing unit 237 can be a digital logical circuit, such as a microcontroller, electrically connected to the rectifier 231, current source 233 and switch unit 238. The control processing unit 237 controls the outputted current of the current source 233 and the switch unit 238 according to the level or phase variation of the DC voltage for adjusting the current amount supplied to the light emitting unit 21c, and thus the light output power of the light emitting unit 21c can be controlled.

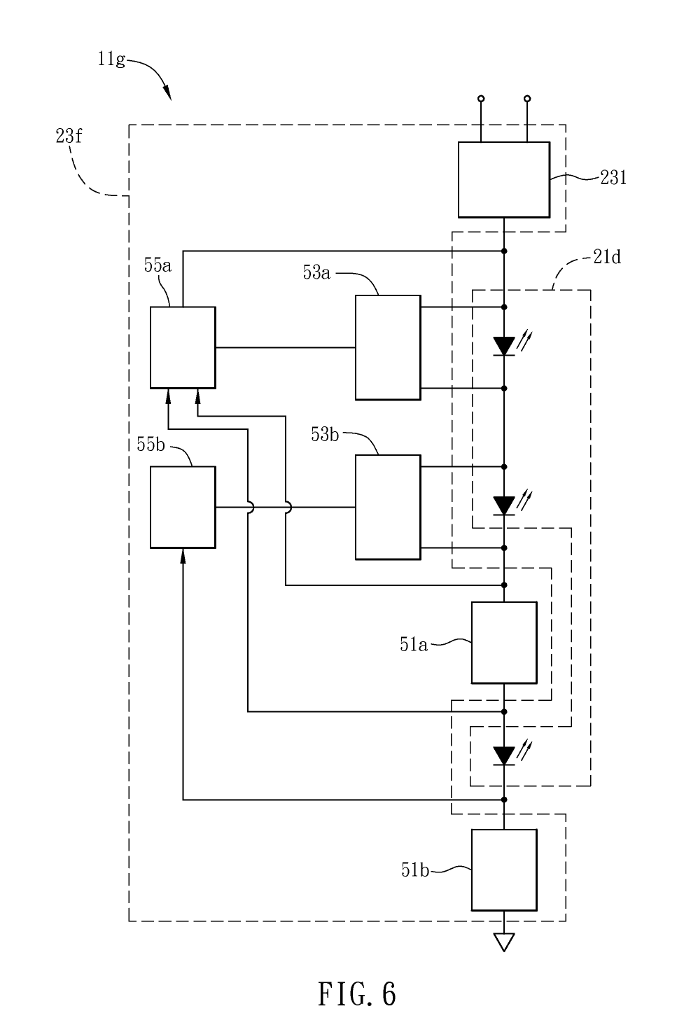

FIG. 6 is a schematic diagram of a light emitting module 11g of the light emitting device according to another embodiment of the invention. The light emitting module 11g includes a light emitting unit 21d and a control circuit 23f. The light emitting unit 21d includes three LEDs connected in series. The control circuit 23f includes a rectifier 231, two detectors 51a, 51b, two switch units 53a, 53b, and two controllers 55a, 55b.

The rectifier 231 is electrically connected to the three-phase AC power source, and receives the phase power sources thereof to output a DC voltage to the light emitting unit 21d. The detectors 51a and 51b detect the light emitting states of the LEDs of the light emitting unit 21d to output control signals, receptively. The switch units 53a and 53b are connected in series, and electrically connected to the corresponding LEDs respectively. The controllers 55a and 55b are electrically connected to the switch units 53a and 53b respectively, and control the “on” and “off' of the corresponding LEDs according to the control signals of the detectors 51a and 51b respectively, for adjusting the number of the turned on LEDs of the light emitting unit 21d.

Practically, the detectors 51a and 51b can be a resistor or a photosensor each, and the switch units 53a and 53b can be a transistor switch each. To be noted, they are just for example and this invention is not limited thereto. In other words, they can be embodied otherwise according to the requirements.

As an embodiment, the detector 51a will detect the light emitting state of one of the LEDs of the light emitting unit 21d to output a control signal to the controller 55a. The light emitting state is, for example, corresponding to the voltage across the detector 51a. Then, the controller 55a will, according to the received control signal, control the switch unit 53a to partially or completely shunt the current supplied to the corresponding LED(s). Since the operation principles of the detector 51b, controller 55b and switch unit 53b are the same as those of the detector 51a, controller 55a and switch unit 53a, they are not described here for conciseness. Thereby, the number of the turned on LEDs of the light emitting unit 21d can be controlled, and thus the light output power of the light emitting unit 21d can be adjusted.

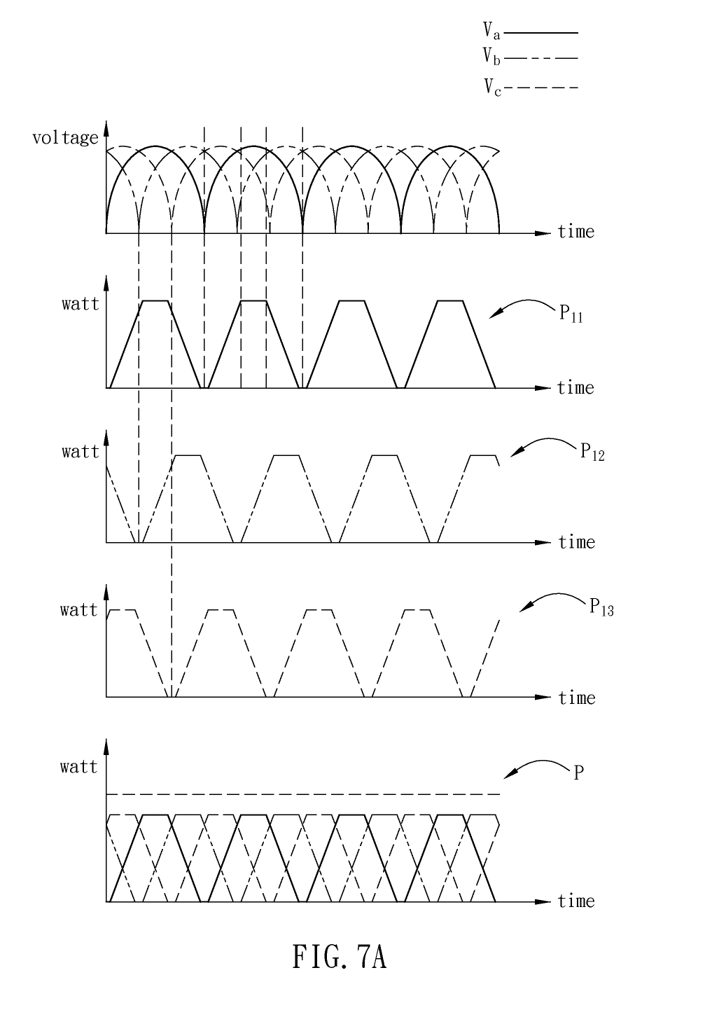

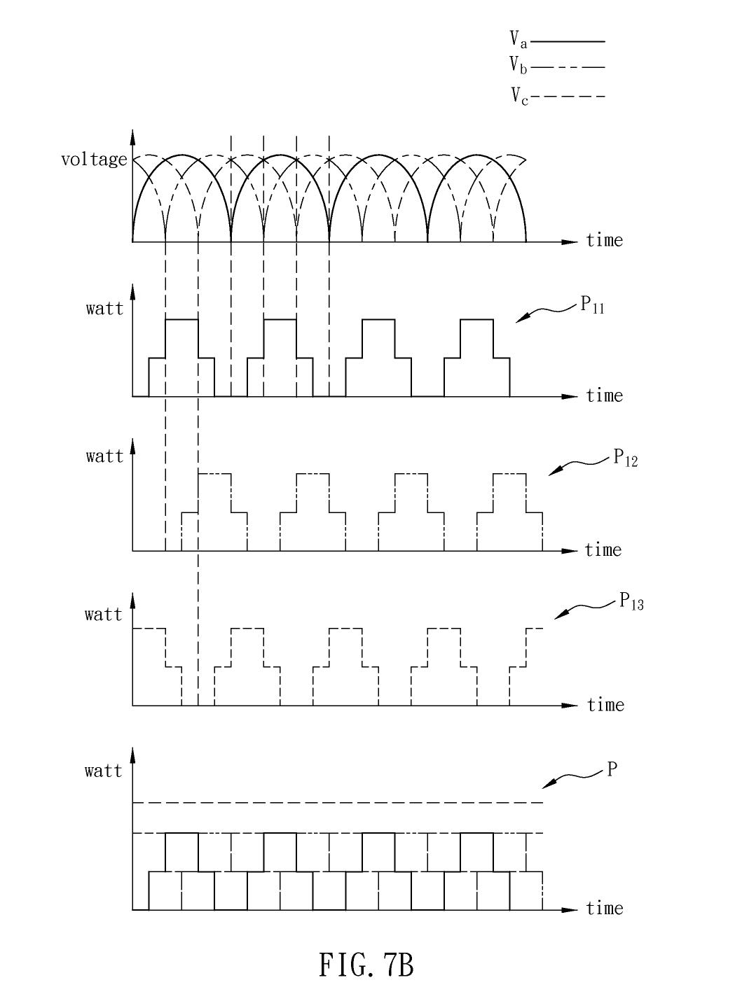

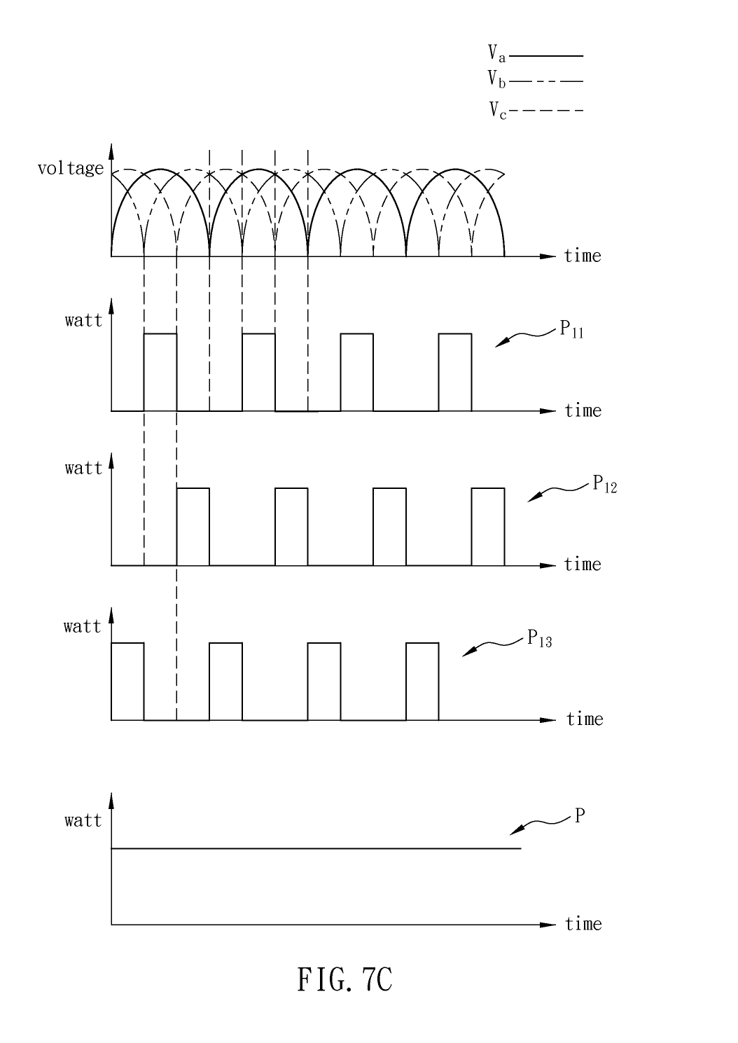

FIGS. 7A to 7C are schematic diagrams showing the light output power waveforms of the light emitting device including the circuit in one of FIGS. 4A, 4B, 5A to 5D and 6 and driven by a three-phase AC power source.

Each of FIGS. 7A to 7C sequentially shows, from top to bottom, the voltage waveforms of the phase power sources V_{A}, V_{B}, V_{C} of the three-phase AC power source after the rectification, the light output power P₁₁ of the light emitting module receiving the phase power source V_{A}, the light output power P₁₂ of the light emitting module receiving the phase power source V_{B}, the light output power P₁₃ of the light emitting module receiving the phase power source V_{C}, and the gross light output power P of the light emitting device.

As shown in FIG. 7A, the light output power waveform of each of the light emitting modules has a trapezoid shape, including a power ascending section, a power descending section and a power stabilized section between the power ascending section and power descending section. Each of the light emitting modules will illuminate weakly with the power descending section, illuminate strongly in the power ascending section, and illuminate steadily in the power stabilized section. The light output power waveforms of the light emitting modules are substantially the same and have phases different from one another by 120°, and besides, the power ascending section of the waveform of one of the light emitting units overlaps the power descending section of the waveform of another of the light emitting units with the complementary slopes. Therefore, the gross light output power can be kept stable.

As shown in FIG. 7B, the light output power waveform of each of the light emitting modules is shaped like at least a protrusion, including two power stabilized sections with lower power and a power stabilized section with higher power that is between the power stabilized sections with lower power. By the circuit design, the three light emitting modules can be designed as their light output power waveforms sum up to a constant for all the sections, and therefore the gross light output power can be kept steady.

As shown in FIG. 7C, the light output power waveforms of the light emitting modules have rectangular shapes and are complementary to one another. In other words, the light emitting modules emit light in a staggered manner.

The above-mentioned light output power waveforms are just for example, and this invention is not limited thereto. The scope of this invention is that the light output power waveforms of the light emitting modules sum up to a constant. Besides, the ripple RMS of the above-mentioned gross light output power of the light emitting modules is less than 10% of the RMS of the gross light emitting power.

In summary, in the light emitting device according to the invention, the electrolytic capacitor is not required for the voltage stabilization, and the light output power of each of the light emitting modules is controlled according to the voltage variation or phase variation of the power source. Thereby, a stable light output power can be provided. Besides, the invention can bring the advantages of a longer lifespan and no flickers, and huge market potential.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A light emitting device electrically connected to a three-phase AC power source, comprising:
three light emitting modules respectively receiving three phase power sources of the three-phase AC power source;
wherein each of the light emitting modules includes a light emitting unit and a control circuit electrically connected to the light emitting unit, each of the control circuits controls the light output power of the corresponding light emitting unit according to the voltage variation or phase variation of the received phase power source, and the three light emitting modules are collectively kept a stable gross light output power.

2. The light emitting device as recited in claim 1, wherein the light emitting unit of each of the light emitting modules includes at least a light emitting diode.

3. The light emitting device as recited in claim 1, wherein the control circuit of each of the light emitting modules includes a resistor.

4. The light emitting device as recited in claim 1, wherein the control circuit of each of the light emitting modules includes:
a first rectifier electrically connected to the three-phase AC power source;
a second rectifier electrically connected to the corresponding light emitting unit;
a first current source electrically connected to the first rectifier to form a first current path; and
a second current source electrically connected to the second rectifier to form a second current path;
wherein the first and second current paths are connected in parallel.

5. The light emitting device as recited in claim 1, wherein the control circuit of each of the light emitting modules includes:
a rectifier electrically connected to the three-phase AC power source and receiving the phase power source to output a DC voltage;
a current source electrically connected to the rectifier and the corresponding light emitting unit; and
a controller electrically connected to the rectifier and the current source, and controlling the light output power of the corresponding light emitting unit according to the level variation or phase variation of the DC voltage.

6. The light emitting device as recited in claim 1, wherein the control circuit of each of the light emitting modules includes:
a rectifier electrically connected to the three-phase AC power source and receiving the phase power source to output a DC voltage;
a current source electrically connected to the rectifier and the corresponding light emitting unit;
a first controller electrically connected to the rectifier and the current source, and controlling the outputted current of the current source according to the level variation or phase variation of the DC voltage;
a second controller electrically connected to the rectifier; and
a switch unit electrically connected to the second rectifier and the light emitting unit;
wherein the second controller controls the switch unit according to the level variation or phase variation of the DC voltage for adjusting the current supplied to the light emitting unit.

7. The light emitting device as recited in claim 1, wherein the light output power waveform of the light emitting unit of each of the light emitting modules has a power ascending section and a power descending section, and the power ascending section of the waveform of one of the light emitting units overlaps the power descending section of the waveform of another of the light emitting units.

8. The light emitting device as recited in claim 7, wherein the power ascending section and the power descending section overlapping each other have complementary slopes.

9. The light emitting device as recited in claim 7, wherein the light output power waveform of the light emitting unit of each of the light emitting modules has a power stabilized section, which is between the power ascending section and the power descending section.

10. The light emitting device as recited in claim 1, wherein the three light emitting modules emit light in a staggered manner.

11. The light emitting device as recited in claim 1, wherein the ripple RMS of the gross light output power of the light emitting modules is less than 10% of the RMS of the gross light emitting power.

12. The light emitting device as recited in claim 1, wherein the light output power waveforms of the light emitting units have phases different from one another by 120°

13. The light emitting device as recited in claim 1, wherein the light output power waveforms of the light emitting units are substantially the same and have phases different from one another by 120°.

14. The light emitting device as recited in claim 1, wherein the control circuit of each of the light emitting modules includes:
a rectifier electrically connected to the three-phase AC power source and receiving the phase power source to output a DC voltage to the light emitting unit;
a plurality of detectors detecting the light emitting states of the LEDs of the light emitting unit to output control signals, receptively;
a plurality of switch units connected in series and electrically connected to the corresponding LEDs respectively; and
a plurality of controllers electrically connected to the switch units respectively, and adjusting the number of the turned on LEDs of the light emitting unit according to the control signals of the detectors respectively.
